(19) United States
(12) Patent Application Publication
(10) Pub. No.: US 2009/0063794 A1
(43) Pub. Date: Mar. 5, 2009

(54) METHOD AND SYSTEM FOR ENHANCED DATA STORAGE MANAGEMENT

(75) Inventor: Robert D. Green, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/847,468

(22) Filed: Aug. 30, 2007

(51) Int. Cl. G06F 12/16

(52) U.S. Cl. 711/162; 711/E12.103

(57) ABSTRACT

A method and system for implementing enhanced data storage management are provided. The method includes compiling a list of all online disks for a data storage environment. For each disk in the list, the method includes querying a backup control database to obtain statistical information for the disk which includes a backup status of the disk. Responsive to the query, the method includes generating a first report that includes the statistical information of each of the disks in which a backup has been performed, and generating a second report for each of the disks in which no backup has been performed. The method further includes using the second report to determine whether to add the disks from the second report to a list of disks scheduled for backup based upon predefined criteria, and adding those disks from the second report to the list of disks scheduled for backup when the results of the determination match the predefined criteria.

### TRADEMARK

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to data storage management, and particularly to a method and system for enhanced backup data storage management.

2. Description of Background

Operating system backup utilities, which manage the backup storage of datasets, handle disks associated with a data storage group construct identified by the backup utility. Those disks that are not associated with the backup utility require some manual processing. For example, such disks need to be manually handled by a storage administrator by adding them to a hierarchical storage manager (HSM) utility parameter file or by a command-line interface for manual processing. There exists a problem when using the HSM utility for full disk backups in that there is no tracking mechanism to report the status of disks to determine whether or not they have been backed up.

Irrespective of the association of disks to the backup utility, problems exist whereby there is no mechanism for reporting the backup tapes used for backing up a particular disk. For instance, one method to determine the status of backups is to manually search HSM job logs to determine for which disks a back up was attempted, and the success or failure of the attempt. In instances where the HSM utility is not available (e.g., loss of HSM control data sets or a disaster recovery situation), there is no method to determine which backup tapes are used to restore a disk.

What is needed therefore, is a way to track, manage, and report disk information including acquiring backup statuses and backup locations of data sets associated with a data storage environment.

### SUMMARY OF THE INVENTION

The shortcomings of the prior art are overcome and additional advantages are provided through the provision of a method for implementing enhanced data storage management. The method includes compiling a list of all online disks for a data storage environment. For each disk in the list, the method includes querying a backup control database to obtain statistical information for the disk, which includes a backup status of the disk. Responsive to the query, the method includes generating a first report that includes the statistical information of each of the disks in which a backup has been performed, and generating a second report for each of the disks in which no backup has been performed. The method further includes using the second report to determine whether to add the disks from the second report to a list of disks scheduled for backup based upon predefined criteria, and adding those disks from the second report to the list of disks scheduled for backup when the results of the determination match the predefined criteria.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which tracks, manages, and reports disk information including acquiring backup statuses and backup locations of data sets associated with a data storage environment.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which enhanced hierarchical data storage management activities may be implemented in accordance with an exemplary embodiment;

FIG. 2 illustrates one example of a flow diagram describing a process for implementing enhanced hierarchical data storage management activities; and

FIGS. 3A-3B illustrate reports generated via the enhanced hierarchical data storage management system.

The detailed description explains the preferred embodiments of the invention, together with advantages and features, by way of example with reference to the drawings.

### DETAILED DESCRIPTION OF THE INVENTION

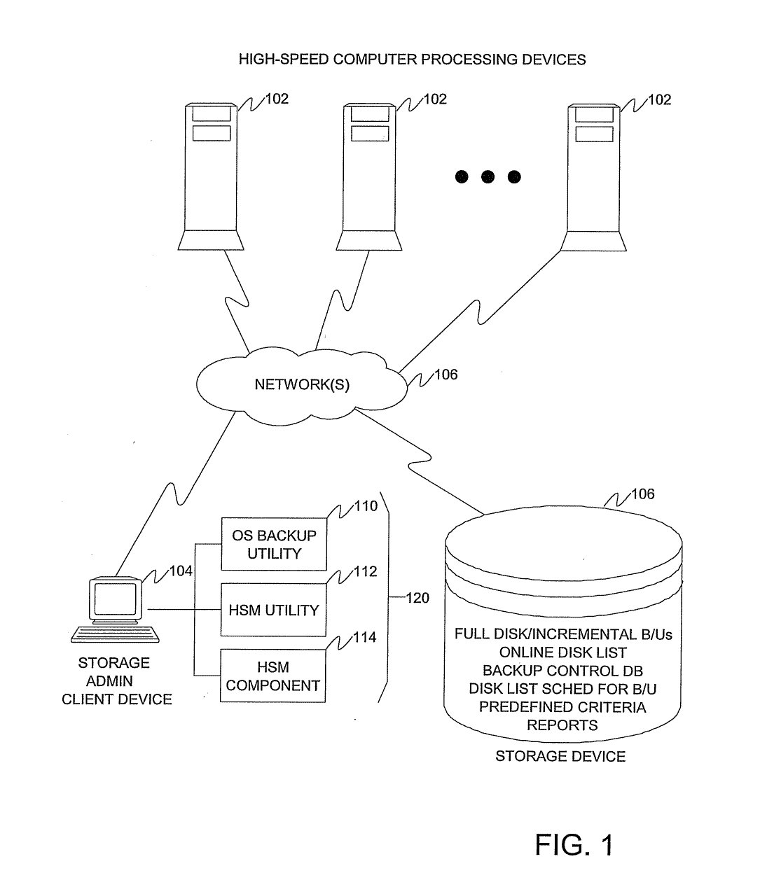

Turning now to the drawings in greater detail, it will be seen that in FIG. 1 there is shown a system upon which enhanced hierarchical data storage management activities may be implemented in an exemplary embodiment. The enhanced hierarchical data storage management activities track, manage, and report disk information including acquiring backup statuses and backup locations of these disks, which are associated with a data storage environment. The system of FIG. 1 includes high-speed computer processing devices 102, client system 104, and storage device 108, each of which are in communication via one or more networks 106.

Each of high-speed computer processing devices 102 may comprise, e.g., a mainframe computer that handles large amounts of data, applications, and associated transactions. By way of illustration, high-speed computer processing devices 102 may be one or more of IBM's® System Z™ mainframes. Each of high-speed computer processing devices 102 may include internal storage (e.g., hard disk drives, disk arrays, magnetic tape media, optical disk drives, etc.). Additionally, high-speed computer processing devices 102 may store disk data sets (e.g., files, databases, libraries, etc.) referred to herein as disk data or disks. Additionally, one or more of the high-speed computer processing devices 102 may store backed up data. As used herein, the term “backed up data” refers to the copying of data from one location on disk to another location, either on the same device (e.g., hard disk) or alternative disk location. The location in which the data is copied is referred to herein as a destination storage device or backup media device. The origination location of the disk data, as well as the destination storage location may include a physical hard disk (internal or external to the high-speed processing device 102), hard disk drive array, magnetic tape, optical disk drive, or the like.

The backed up data may be performed as one or both of an incremental back up process and a full disk back up process. As used herein, the term “full disk backup” refers to the copying of the entire contents of a storage media, the entire contents of a partition associated with a storage media, the entire contents of an array of partitions of a storage media, or the entire contents of complete storage media devices that comprise a logical volume. Thus, a full disk may include the entire contents of the respective media or media partitioned portion(s) thereof. As further used herein, the term “incremental back up” refers to a copy of the contents of selected data sets (e.g., files or databases), which may include only those data sets in which a new data set or modification to an existing data has been determined since the previous full and/or incremental backup occurred. It will be understood that several incremental back ups may be implemented between any two sequential full disk back ups. Backup processes may include indexing files that identify a backup time (e.g., timestamp) and the identification of the files/disks or media.

The backups and management thereof may be performed by one or more applications executing on the client device 104. The client device 104 may be implemented as a general-purpose computer processing device. The client device 104 may be operated by a storage administrator who is responsible for the management of the data associated with the high-speed processing devices 102, as well as storage device 108. The client device 104 is also referred to herein as a storage administrator client system in order to readily distinguish device 104 from the high-speed computer processing devices 102 shown in FIG. 1.

As indicated above, the client device 104 executes one or more applications for implementing the enhanced hierarchical data storage management activities. These one or more applications are collectively referred to as storage management application 120. The enhanced hierarchical data storage management activities may be implemented as a standalone product or may be integrated into existing off-the-shelf products. For example, storage management application 120 may include an operating system backup utility 110 (e.g., IBM's® Z/OS™ series Data Facility Storage Management Subsystem (DFSMS)). Storage management application 120 may further include a hierarchical storage management utility 112 (e.g., IBM's® DFSMShsm). The backup utility 110 and the hierarchical storage management (HSM) utility 112 manage the storage and backup processes of data disks associated with the high-speed computer processing devices 102 and the storage device 108. The backup utility 110 compares timestamps (i.e., date and time) on data sets and compares the dates with the timestamps of the previous backup. The HSM utility 112 refers to a tiered storage technique used to manage data that is not used on a regular basis. The HSM utility 112 moves data from one location to another (e.g., from a high cost storage media to a low cost storage media based upon the frequency of data usage or the relevance of the data).

In an exemplary embodiment, the hierarchical storage management utility 112 includes a hierarchical storage management (HSM) component 114 for assisting in implementing the enhanced hierarchical data storage management activities, and in particular, generating reports. These reports may be useful in assisting a storage administrator in identifying failed or missed backup windows. The HSM component 114 may be a routine implemented, e.g., using an object-oriented programming language. HSM component 114 will be described further herein.

Storage device 108 may be implemented using memory contained in the client system 104 or it may be a separate physical device. In exemplary embodiments, the storage device 108 may be in communication with the client system 104 over network 106 (e.g., logically addressable as a consolidated data source across a distributed environment that includes one or more networks 106. Alternatively, storage device 108 may be in direct communication with the client system 104 (via, e.g., cabling). Storage device 108 stores a variety of information for use in implementing the enhanced hierarchical data storage management activities. As shown in FIG. 1, storage device 108 stores one or more: full disk back ups, incremental backups, online disk lists, backup control database, lists of disks scheduled for backup; predefined criteria used by the HSM component 114; and reports generated by the enhanced hierarchical data storage management activities. These items are described further herein. While these items are collectively shown in FIG. 1 to be stored in a single repository (i.e., storage device 108) for convenience of illustration, it will be understood that the items may be stored separately (in two or more alternative storage devices).

The high-speed computer processing devices 102 and the storage device 108 are collectively referred to as a data storage environment. Thus, the data storage environment includes memory internal or external to one or more of the high-speed computer processing devices 102.

Network 106 may be any type of known network including, but not limited to, a wide area network (WAN), a local area network (LAN), a global network (e.g. Internet), a virtual private network (VPN), and an intranet.

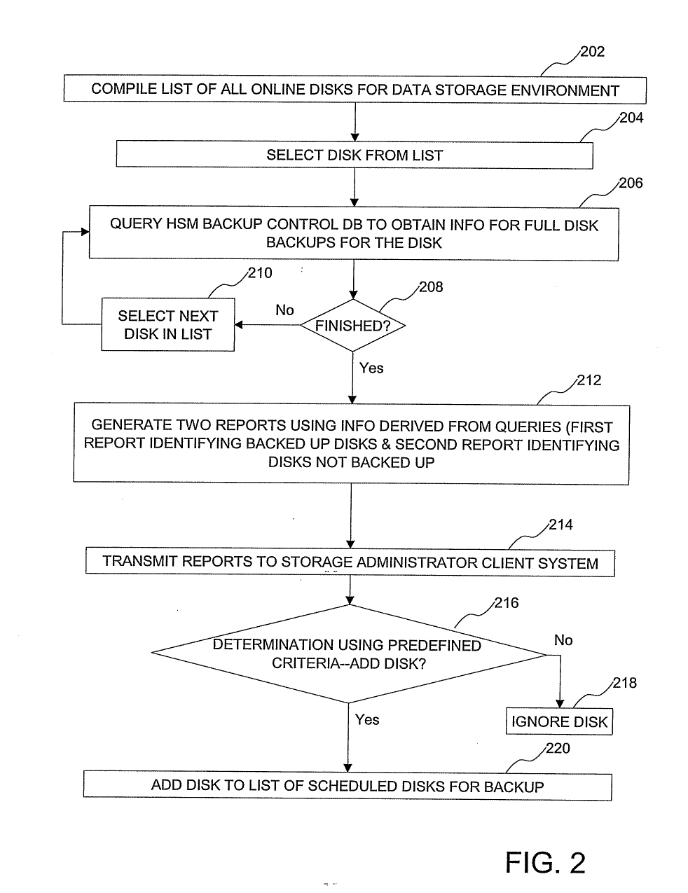

As indicated above, the enhanced hierarchical data storage management activities track, manage, and report disk information including acquiring backup statuses and backup locations of data sets associated with a data storage environment. Turning now to FIG. 2, an exemplary process for implementing enhanced hierarchical data storage management activities will now be described. At step 202, the storage management application 104 compiles a list of all online disks for the data storage environment. Online disks refer to those disks that are stored internally with respect to the high-speed computer processing devices 102. If the backup utility employed by client system 104 is IBM's® DFSMS, the compilation may be implemented using DFSMS's Access Method for Catalogs using the associated function DCOLLECT.

Once the list has been compiled, a disk is selected from the list at step 204 by the storage management application 120. The HSM component 114 queries the backup control database stored in storage device 108 to obtain information regarding the disk at step 206. The backup control database includes entries added by the backup utility 110 and HSM utility 112 for disks associated with the data storage environment. The entries include statistical information including the a backup status of the disk, a disk identifier, and a backup timestamp of the previous backup of the disk, if applicable, and the backup status identifying whether a full disk backup has been performed for the disk.

At step 208, it is determined whether each of the disks in the list has been queried. If not, the HSM component 114 selects the next disk in the list at step 210 and the process returns to step 206. Otherwise, if each of the disks in the list has been queried, the HSM component 114 generates two reports using the results of the queries at step 212. The first report includes the statistical information of each of the disks in which a backup has been performed. The second report is generated for each of the disks in the list in which no backup has been performed. The second report identifies the disks (e.g., the media and storage location on the media). A backup may not have been performed if, e.g., the data is transient or temporary data. These reports may be useful in assisting a storage administrator in identifying failed or missed backup windows.

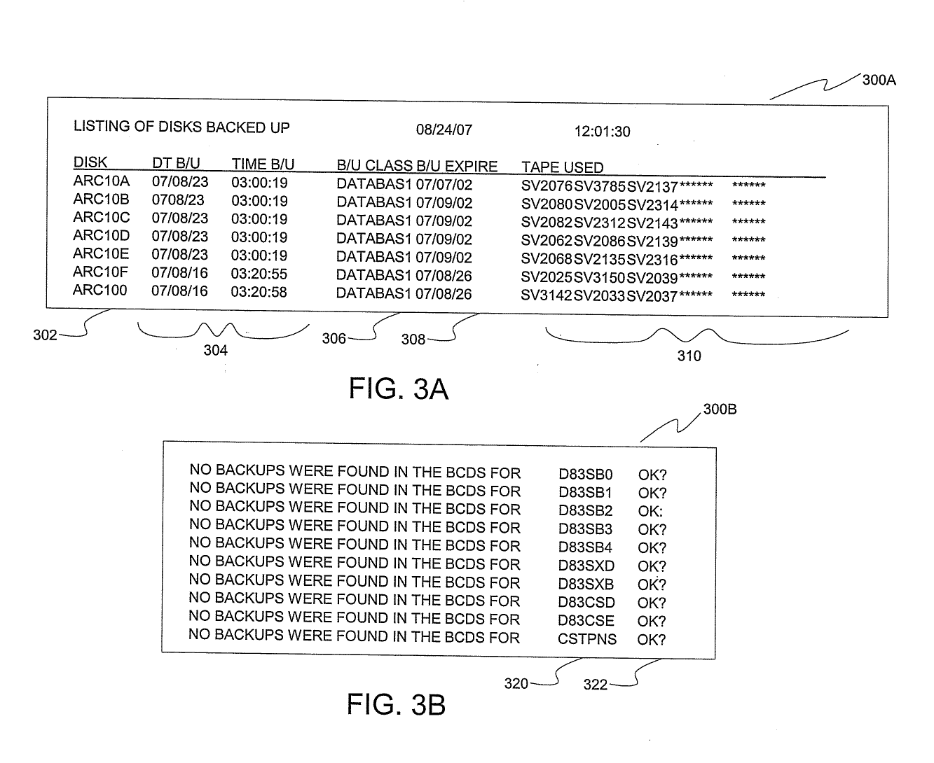

At step 214, the first and second reports are transmitted to the storage administrator client system 104. A sample first report 300A, which lists disks in which a back up has been determined, is shown in FIG. 3A and a sample second report 300B, which lists disks in which a back has not been determined, is shown in FIG. 3B. As shown in FIG. 3A, the first report identifies the disk in column 302, the date and time of the previous backup for the disk in columns 304, a backup class for the disk in column 306 (i.e., a class that identifies groups of backup data sets), a date in which the backed up version expires in column 308, and a serial number of a destination storage location of the backed up disk in column 310. As shown in FIG. 3A, the destination storage location may be one or more tape cartridges.

As shown in FIG. 3B, the second report lists those disks in which no backup as been performed. The list identifies the respective disks in column 320.

At step 216, a determination is made as to whether or not to add the disks from the second report to a list of disks scheduled for backup (the scheduled disks stored in storage device 108). This determination may be made using predefined criteria. The predefined criteria identify priority values associated with the data sets for the disks, whereby high priority values are assigned to non-transient, proprietary, and confidential data, or other data that is of importance to an enterprise implementing the enhanced hierarchical data storage management activities. Each disk or data set within a disk may be assigned the priority value used in the determination process. In an exemplary embodiment, the parameter “OK?” in column 322, as shown in the second report of FIG. 3B, may be used to initiate the determination process for the respective disk.

At step 218, those disks from the second report in which results of the determination indicate a match with the predefined criteria are automatically added to the list of scheduled disks for backup via the storage management application 120. Remaining disks from the second report may be simply ignored at step 220. The first report may be used for review and later stored for future reference.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing enhanced data storage management, comprising:
compiling a list of all online disks for a data storage environment, the data storage environment including memory internal or external to one or more high-speed computer processing devices;
for each disk in the list, querying a backup control database to obtain statistical information for the disk, the statistical information including a backup status of the disk, a disk identifier, and a backup timestamp of the previous backup of the disk, if applicable, and the backup status identifying whether a full disk backup has been performed for the disk; and
responsive to the query:
generating a first report that includes the statistical information of each of the disks in which a backup has been performed;
generating a second report for each of the disks in the list in which no backup has been performed, the second report identifying the respective disks;
transmitting the second report to a storage administrator client system;
making a determination of whether to add the disks from the second report to a list of disks scheduled for backup, the determination based upon predefined criteria; and
adding those disks from the second report to the list of disks scheduled for backup when the results of the determination match the predefined criteria.

2. The method of claim 1, wherein the statistical information further includes:
a date in which a backed up disk expires;
a serial number of a destination storage location of the backed up disk; and
a backup class identifying groups of backed up files.

3. The method of claim 2, wherein the online disks comprise full disk data sets including at least one of:
the entire contents of a partition associated with a storage medium;
the entire contents of an array of partitions of a storage medium;
the entire contents of complete storage media devices that comprise a logical volume; and
the entire contents of a storage medium;
wherein the storage medium comprises at least one of:
an internal or external hard disk;
an optical disk; and
a magnetic tape; and
wherein the destination storage location includes at least one of:
an internal or external hard disk;
an optical disk; and
a magnetic tape.

4. The method of claim 3, wherein the predefined criteria identify priority values associated with the data sets for the disks, whereby high priority values are assigned to non-transient, proprietary, and confidential data.

5. The method of claim 1, further comprising:
transmitting the first report to the storage administrator client system for review and storage.

6. A system for implementing enhanced data storage management, comprising:
a computer processing device; and
a storage management application executing on the computer processing device, the storage management application implementing a method, comprising:
compiling a list of all online disks for a data storage environment, the data storage environment including memory internal or external to one or more high-speed computer processing devices;
for each disk in the list, querying a backup control database to obtain statistical information for the disk, the statistical information including a backup status of the disk, a disk identifier, and a backup timestamp of the previous backup of the disk, if applicable, and the backup status identifying whether a full disk backup has been performed for the disk; and
responsive to the query:
generating a first report that includes the statistical information of each of the disks in which a backup has been performed;
generating a second report for each of the disks in the list in which no backup has been performed, the second report identifying the respective disks;
transmitting the second report to a storage administrator client system;
making a determination of whether to add the disks from the second report to a list of disks scheduled for backup, the determination based upon predefined criteria; and
adding those disks from the second report to the list of disks scheduled for backup when the results of the determination match the predefined criteria.

7. The system of claim 6, wherein the statistical information further includes:
a date in which a backed up disk expires;
a serial number of a destination storage location of the backed up disk; and
a backup class identifying groups of backed up files.

8. The system of claim 7, wherein the online disks comprise full disk data sets including at least one of:
the entire contents of a partition associated with a storage medium;
the entire contents of an array of partitions of a storage medium;
the entire contents of complete storage media devices that comprise a logical volume; and
the entire contents of a storage medium;
wherein the storage medium comprises at least one of:
an internal or external hard disk;
an optical disk; and
a magnetic tape; and
wherein the destination storage location includes at least one of:
an internal or external hard disk;
an optical disk; and
a magnetic tape.

9. The system of claim 8, wherein the predefined criteria identify priority values associated with the data sets for the disks, whereby high priority values are assigned to non-transient, proprietary, and confidential data.

10. The system of claim 6, wherein the storage management application further performs:
transmitting the first report to the storage administrator client system for review and storage.
